(19) United States
(12) Patent Application Publication
(10) Pub. No.: US 2004/0179228 A1
(43) Pub. Date: Sep. 16, 2004

(54) Indication of image content modification

(76) Inventors: Mark McCluskey, Escondido, CA (US); Bret M. Strain, San Diego, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/386,289

(22) Filed: Mar. 10, 2003

(51) Int. Cl. G06F 17/30; G06F 15/00; H04N 1/21

(52) U.S. Cl. 358/1.15; 358/1.17; 358/403

(57) ABSTRACT

Systems, methods, and devices for indication of image content modification are provided. A method includes receiving image data from an image device. The received images are analyzed for descriptor information. And, an indication of modified image content in the received image data is provided based on the descriptor information.

Certain imaging devices having sophisticated image displays allow users to see what images are to be printed from an image display on the control panel. Certain other devices, however, do not have an image display or include a limited display which is not adapted for displaying actual images. These other products require a user to print an index page to determine which images are to be printed. The index page consists of small thumbnails of the images that represent the contents of received image data, such as image data received from a memory card. Generally, a user references the index page(s) to enter image number(s) into the printer's control panel to print selected images. However, if an image source or medium, e.g. memory card, is removed from an image device and images are deleted or added to this source, e.g. by a digital camera, another image device, and/or from a computer, then the index page numbering scheme is no longer accurate. To determine correct image numbers or image indicators, another index page may have to be printed.

As noted above, certain image devices, such as photo printers, afford only a limited LCD display on the control panel of the device. These devices generally have either an icon or alphanumeric display that allows the user to enter an image number to be printed. Some image numbers are complex and require measurable mental calculation in order to avoid entering the wrong image number. In these devices, reliance on an index page to reference which images to print can be high.

Some image devise, such as digital cameras, provide image numbers on an LCD of the camera. Thus, in some instances a user may enter an image number into the control panel of a photo printer by referencing an image number from the LCD of the camera. Unfortunately, these numbers are not always accurate or do not correlate between devices from different manufacturers.

The above illustrates that there is no sure way to ascertain whether image content on an image source, such as a memory card, has been altered or modified absent printing a new index page. However, printing out a new index page each time a memory card is inserted into an imaging device is less than desirable since doing so expends consumables such as printing paper or other print medium. Moreover, the continued modification of images on a memory source, presents exchange hurdles for users who want to know image content for purposes of sharing images with others.

Currently, with photo printers, the safest approach to know image content requires a new index page to be printed each time a memory card is inserted into an imaging device. As a result, users may less frequently choose to print images. In devices which do not have image selection displays, a reduced confidence level exists that an image indicator correctly references an image which is desired for printing. Users may experience frustration in the amount of effort which has to be expended to insure that the image indicator they enter to a control panel on a photo printer correctly references an image they desire to print.

### BRIEF DESCRIPTION OF THE DRAWINGS

FIG. 1 illustrates a system environment according to various embodiments of the present invention.

FIGS. 2A and 2B illustrate embodiments of devices which are operable to implement or which can include embodiments of the present invention.

FIG. 2C illustrates a block diagram embodiment of one or more components includable in a device, such as the devices shown in FIGS. 2A and 2B.

FIG. 3 illustrates an embodiment of an index page having thumbnails of the images that represent the contents of received image data.

FIGS. 4A-4C illustrate a number of index page embodiments which can be created and/or provided by a device or system, according to various embodiments of the present invention.

FIG. 5 illustrates a method embodiment according to the teachings of the present invention.

FIG. 6 illustrates a method embodiment for indicating image content modification according to the teachings of the present invention.

FIG. 7 illustrates another method embodiment for indicating image content modification according to the teachings of the present invention.

FIG. 8 illustrates a method embodiment for comparing received image data to a set of descriptors in previously received image data according to the teachings of the present invention.

### DETAILED DESCRIPTION

The present invention provides techniques for indicating image content modification and includes systems and devices for performing the same. Various embodiments enable quick assessment as to whether received image content, whether received from a device or contained in a medium, has been modified from previously received image data. That is, in various embodiments, a method is provided to intelligently and easily determine if received image data has been modified or changed in reference to previously received image data.

As one of ordinary skill in the art will appreciate upon reading this disclosure, various embodiments of the invention can be performed in one or more devices, different device types, and system environments including networked environments. The discussion which follows illustrates, by way of example and not by way of limitation, various system environments and devices that implement or include embodiments of the present invention.

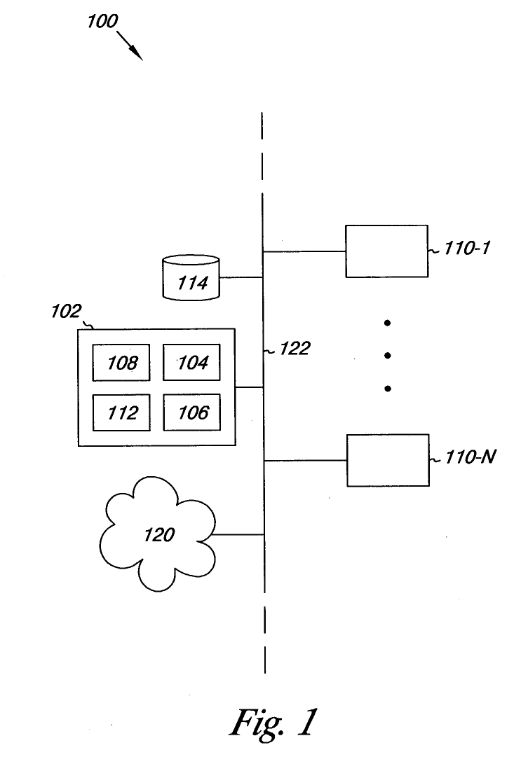

FIG. 1 illustrates a system environment 100 according to various embodiments of the present invention. As shown in FIG. 1, the system includes a printing device 102. In various embodiments, including the embodiment shown in FIG. 1, the printing device 102 can include one or more processors and/or application modules 104 and one or more memory devices 106. The one or more processors and/or application modules 104 are operable on computer readable instructions for processing information and data as the same will be known and understood by one of ordinary skill in the art. In various embodiments of the invention, the one or more processors and/or application modules 104 are operable on computer readable instructions for interpreting received image data.

In the various embodiments, the one or more memory devices 106 include memory devices 106 on which computer readable instructions, data, and other information can be stored, temporarily or otherwise. The one or more memory devices 106 can include fixed memory, such as a hard drive, a memory chip on a printed circuit board, and the like. The one or more memory devices 106 can include memory devices 106 such as Non-Volatile (NV) memory (e.g. Flash memory), RAM, ROM, DDRAM, and the like.

As shown in the embodiment of FIG. 1, the printing device 102 can include a printing device driver 108 and a print engine 112. In various embodiments of FIG. 1, additional printing device drivers can be located off the printing device 102 such as for example on a remote device, e.g. remote device 110-1 in FIG. 1. Such additional printing device drivers can be an alternative to the printing device driver 108 located on the printing device 102 or provided in addition to the printing device driver 108. As one of ordinary skill in the art will understand, a printing device driver 108 is operable to create a computer readable instruction set for a print job utilized for rendering images by the print engine 112. Printing device driver 108 includes any printing device driver suitable for carrying out various aspects of the present invention. That is, the printing device driver can take data from one or more software applications and transform the data into a print job.

As one of ordinary skill in the art will appreciate upon reading this disclosure, the printing device 102 includes a printing device operable to print images. In the various embodiments, the printing device 102 can include a photo printer such as the line of photosmart printers sold by the Hewlett-Packard Company. In the various embodiments, the printing device 102 can include a multi-function device. For example, Hewlett Packard produces several devices that provide printing, copying, and scanning. Additionally, some of these multi-function devices also include faxing capabilities. These types of devices are generally referred to as PCS (Printing/Copying/Scanning) devices or as All-in-One (AiO) devices.

As shown in the embodiment of FIG. 1, printing device 102 can be networked to one or more remote devices 110-1, . . . , 110-N over a number of data links, shown as 122. As one of ordinary skill in the art will appreciate upon reading this disclosure, the number of data links 122 can include one or more physical, one or more wireless connections, and any combination thereof, as part of a network. That is, the printing device 102 and the one or more remote devices 110-1, . . . , 110-N can be directly connected and/or can be connected as part of a wider network having a plurality of data links 122.

In various embodiments, the one or more remote devices 110-1, . . . , 110-N can include an image device such as a digital camera. As used herein, the term imaging devices is intended to include photo printers, digital cameras, All-in-One (AiO) devices, among others of the like, which can operate on image data. The invention is not limited to those imaging devices expressly listed herein. One of ordinary skill in the art will appreciate the numerous types of digital cameras available in the consumer market for recording digital images. Many of these digital cameras have a display, such as an LCD, associated with the camera which allows users to rapidly review and optionally remove images contained on a memory medium of the camera.

It is noted that any number of remote devices and remote device types 110-1, . . . , 110-N can be networked to the printing device 102. The invention is not so limited. That is, in various embodiments, the one or more remote devices 110-1, . . . , 110-N can include a remote device such as a wireless phone, a personal digital assistant (PDA), or other handheld device of like.

In various embodiments, the one or more remote devices 110-1, . . . , 110-N can include a remote device 110 such as a desktop computer, laptop computer, a workstation, among other device types. In some instances, one or more remote devices 110-1, . . . , 110-N can include one or more peripheral devices distributed within the network. Examples of peripheral devices include, but are not limited to, scanning devices, fax capable devices, copying devices, and the like. As noted above, in various embodiments a printing device 102 can include a multifunction device having several functionalities such as printing, copying, and scanning included. As will be known and understood by one of ordinary skill in the art, such remote devices 110-1, . . . , 110-N can also include one or more processors and/or application modules suitable for running software and can include one or more memory devices thereon.

As shown in the embodiment of FIG. 1, a networked system 100 can include one or more networked storage devices 114, e.g. remote storage database and the like. Likewise, the system 100 can include one or more Internet connections 120.

As one of ordinary skill in the art will appreciate upon reading this disclosure, the network described herein can include any number of network types including, but not limited to a Local Area Network (LAN), a Wide Area Network (WAN), a Personal Area Network (PAN), and the like. And, as stated above, data links 122 within such networks can include any combination of direct or indirect wired and/or wireless connections, including but not limited to electrical, optical, and RF connections.

As one of ordinary skill in the art will appreciate upon reading this disclosure, memory, such as memory 106 and memory 114, can be distributed anywhere throughout a networked system. Memory, as the same is used herein, can include any suitable memory for implementing the various embodiments of the invention. Thus, memory and memory devices include fixed memory and portable memory. Examples of portable memory include memory cards, memory sticks, flash cards and the like. Other memory mediums include CDs, DVDs, and floppy disks. The invention, however, is not limited to any particular type of memory medium and is not limited to where within a device or networked system a set of computer instructions reside for use in implementing the various embodiments of invention. One of ordinary skill in the art will appreciate the manner in which software, e.g. computer readable instructions, can be stored on a memory medium.

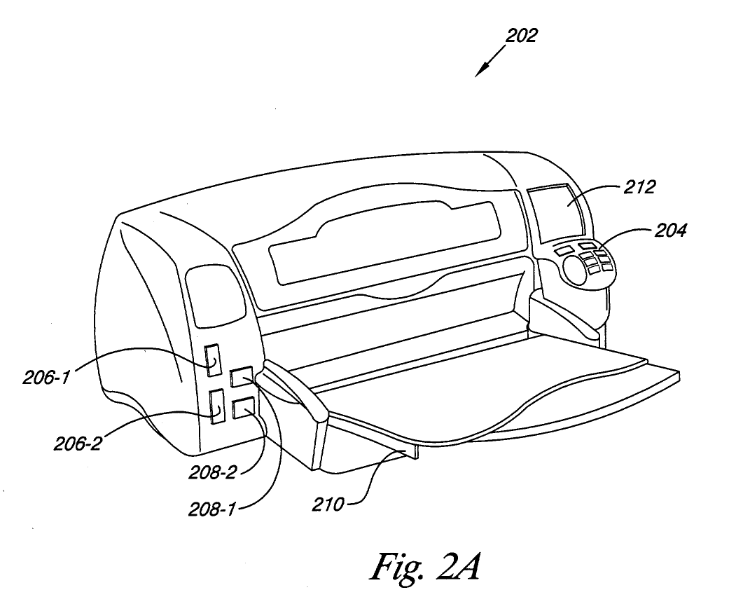

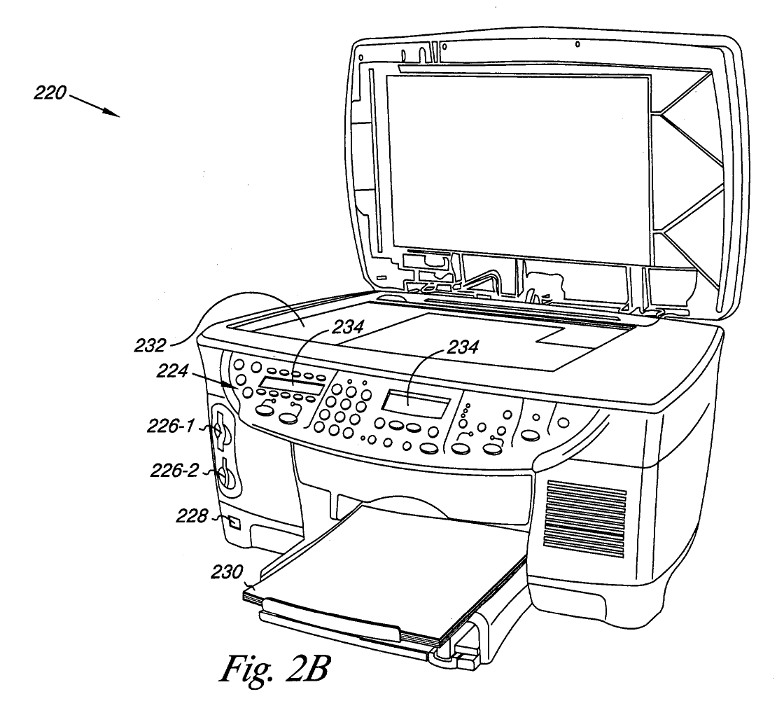

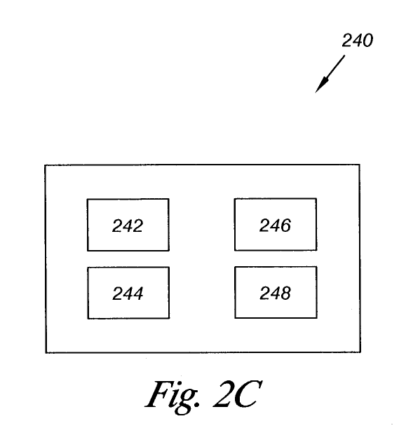

FIGS. 2A and 2B illustrate embodiments of devices are operable to implement or include embodiments of the present invention. As one of ordinary skill in the art will appreciate upon reading this disclosure, embodiments of the invention are not limited to inclusion with or implementation on those devices illustrated in FIGS. 2A and 2B.

FIG. 2A illustrates an embodiment of a photo printer 202. One of ordinary skill in the art will be familiar with the purpose and functionality of a photo printer. And, as one of ordinary skill in the art will appreciate upon reading this disclosure, the photo printer 202 illustrated in the embodiment of FIG. 2A can operate as a stand alone device and can further be used as a printing device in a networked system such as the printing device 102 shown in the networked system 100 of FIG. 1.

Photo printers, such as photo printer 202, are operable to receive image data from one or more sources and can operate on such data to transfer the image data to print media. As shown in the embodiment of FIG. 2A, the photo printer 202 can include one or more data input mechanisms. As shown in the embodiment of FIG. 2A, the one or more data input mechanisms include one or more input keys 204, such as on a control panel, one or more media slots 206-1 and 206-2 operable to receive one or media cards, such as a flash memory card, and one or more data ports 208-1 and 208-2 operable to receive additional data input.

By way of example, and not by way of limitation, many photo printers allow users to conveniently input a memory card from a digital camera. As one of ordinary skill in the art will appreciate upon reading this disclosure, the one or more data ports 208-1 and 208-2 can include a data port operable to receive parallel or serial data connection. For example, the one or more data ports 208-1 and 208-2 can include a data port configured to receive a high speed serial cable connection, such as a USB cable. The invention, however, is not so limited. The one or more data ports 210-1 and 210-2 can further include a data port configured to receive data in a wireless fashion, such as by using an IR or Bluetooth wireless mechanism.

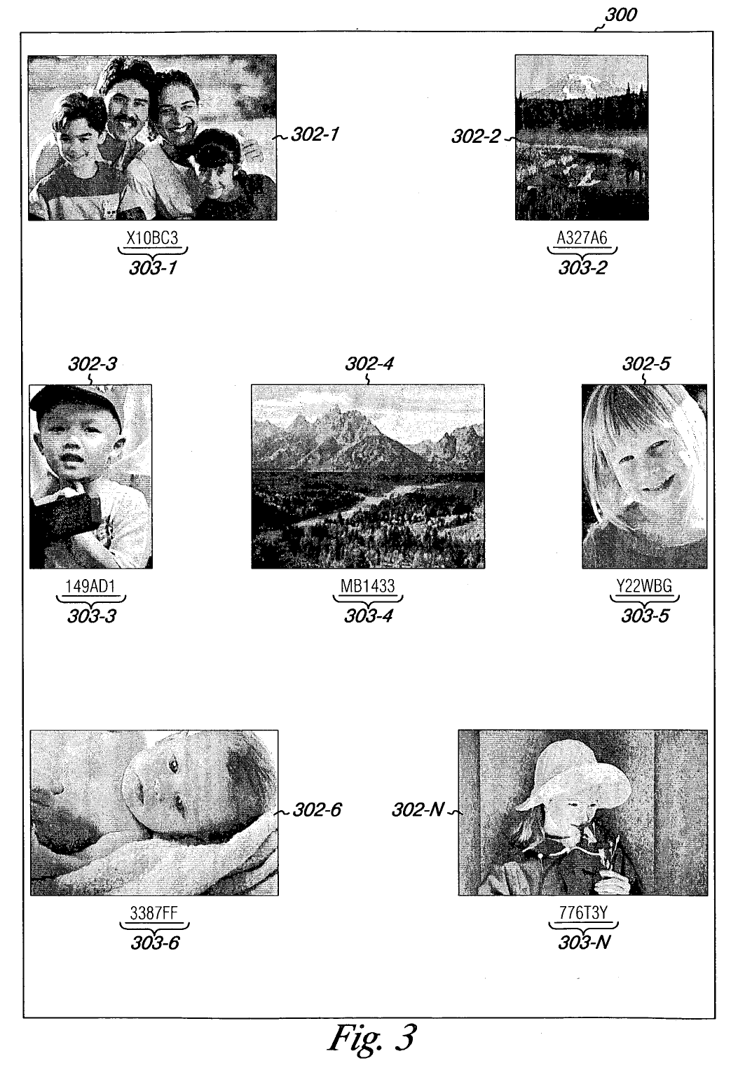

As one of ordinary skill in the art will appreciate, the photo printer 202 embodiment of FIG. 2A is thus operable to obtain data, of any type, from any number of sources. As one of ordinary skill in the art will appreciate upon reading this disclosure, data in the various embodiments includes information such as user commands, image data, and computer readable instructions or instruction sets, among others. As shown in the embodiment of FIG. 2A, the photo printer 202 includes a print media handling device 210. In various embodiments of the invention, print media such as paper can be provided to the media handling device 210. In various embodiments, a memory card containing image data can be inserted into a media slot, e.g. 206-1 and the photo printer 202 can be instructed using input keys 204 to print an index page having one or more representations of the image content on the memory card. The index page can then be delivered as an output on the media handling device 210. That is, in various embodiments, an index page is generated which consists of small thumbnails of the images that represent the contents of the memory card. Generally, an index page, such as shown and discussed in FIG. 3 below, will include an image number associated with each of the images provided on the index page. A user can enter selected image numbers into the photo printer 202, using the input keys 204, in reference to those image numbers on the index page. The photo printer 202 can operate on the selected image numbers to print selected images. As shown in the embodiment of FIG. 2A, some photo printers can include a display screen 212, such as an LCD, to assist in entering, referencing and confirming selected image numbers. In various embodiments of the present invention, a photo printer 202 includes an input key 214 operable to print modified image content as the same is described in more detail below.

FIG. 2B illustrates an embodiment of a multi-function device 220, such as an All-in-One (AiO) device 220, suitable for use with various embodiments of the present invention. As one of ordinary skill in the art will appreciate upon reading this disclosure, the AiO device 220 illustrated in the embodiment of FIG. 2B can operate as a stand alone device and can further be used as a printing device in a networked system such as the printing device 102 shown in the networked system 100 of FIG. 1.

In the embodiment of FIG. 2B, the multi-function device 220 is illustrated having one or more data input mechanisms. In the embodiment shown in FIG. 2B, the one or more data input mechanisms include one or more input keys 224, one or more memory media slots 226-1 and 226-2, and one or more data ports 228. As shown in the embodiment of FIG. 2B, the multi-function device 220 can include a print media handling component 230. And, as shown in the embodiment of FIG. 2B, the multi-function device can include a scanning/copying input 232 and one or more display screen user interfaces 234. As one of ordinary skill in the art will appreciate, the multi-function device 220 embodiment of FIG. 2B is thus operable to obtain data, of any type, from any number of sources.

FIG. 2C illustrates a block diagram embodiment of one or more components includable in a device, such as the devices shown in FIGS. 2A and 2B. The embodiment of FIG. 2C illustrates a device 240 including one or more processors 242 and one or more application modules 244, suitable for operating on software and computer executable instructions. In the embodiment of FIG. 2C, the device 240 is further illustrated having one or more resident memory mediums 246 and one or more removable or portable memory mediums and/or data ports 248 as the same have been described herein. In various embodiments, the one or more portable memory mediums can include selectably insertable memory mediums, such as memory cards. The invention, however, is not so limited.

As stated herein, various embodiments of the invention can be performed by software, application modules, and/or computer executable instructions, operable on the systems and devices described above or otherwise, for carrying out the aspects of the present invention. As one of ordinary skill in the art will appreciate upon reading this disclosure and practicing the invention, software, application modules, and/or computer executable instructions, suitable for carrying out the aspects of the present invention, can be resident in a single device, e.g. photo printer 202 and/or AiO 220, or the same can be resident in more than one device across several and even many locations, such as in a distributed computing environment, e.g. system 100.

In the various system and device embodiments shown above, a set of computer readable instructions are operable on a photo printer 202, an AiO 220, and/or a printing device 102, to access and receive image data from one or more sources. That is, in various embodiments, the image data can be received from a memory medium such as an optical or magnetic disc, memory card and/or memory stick. Similarly, the image data can be accessed over a network, including and any combination of wireless (e.g. RF, IR, Bluetooth and the like) and/or hardwired (e.g. copper wire, optical fibers, and the like) data links to receive the image data from one or more remote devices across a networked system environment, including over the Internet.

In various embodiments of the invention, one or more sets of computer executable instructions operable to analyze received image data and detect and/or determine whether the received image data has been modified from previously received image data. In various embodiments, analyzing received image data to detect or determine whether the received image data has been modified includes analyzing the received images for descriptor information. As used herein, the term descriptors includes, but is not limited to, metadata as the same will be known by one of ordinary skill in the art. One of ordinary skill in the art will appreciate that metadata can include file size information, source information, identifier information (e.g. a camera make and model), setting information (e.g. different setting within a camera), and header information, among other information.

In various embodiments, the set of computer readable instructions are operable to compare the received image data to a set of descriptors for previously received image data. In various embodiments, the set of computer readable instructions are operable to provide an indication of differences in received image data based on the comparison. And, in various embodiments, analyzing the received image data includes performing a Cyclic Redundancy Check (CRC) computation on received image data content and comparing signatures defined by the CRC computation to one or more CRC signatures storable on one or more memory medium within a device such as a photo printer 202, an AiO 220, and/or a printing device 102.

As one of ordinary skill in the art will appreciate upon reading this disclosure, the likelihood of two sets of received image data whose contents differ, but that map to the same CRC signature is very small. And, as one of ordinary skill in the art will appreciate upon reading this disclosure, the signature created by the CRC process is storable on a non-volatile memory of a receiving device such as a photo printer 202, an AiO, and/or a printing device 102 for later reference. As one of ordinary skill in the art will appreciate upon reading this disclosure, a list of CRC signatures is finite, but the compactness of a CRC signature allows for many signatures to be stored in a relatively small amount of memory.

As one of ordinary skill in the art will appreciate upon reading this disclosure, the general class of functions known as Cyclic Redundancy Check (CRC) functions, which are polynomials over GF(2), are incremental functions and will provide position sensitive digital signatures. There are many polynomials for generating CRCs. One example includes, by way of example and not by way of limitation, 32-bit ANSI X. 3.66 CRC Checksum files that appear in FIPS PUB 71 and in FED-STD-1003. The invention, however, is not limited to any particular class of polynomials for generating CRCs.

As one of ordinary skill in the art will understand upon reading this disclosure, embodiments according to the teachings of the present invention can obviate the need to print another index page when received image data content has not been modified. Additionally, embodiments of the present invention can provide an alert when received image data content received has been modified. In various embodiments, a new index page can be printed when image content has been modified. In various embodiments, an index page can be printed which uniquely identifies “modified and/or new” image data content. And, in various embodiments, an index page can be printed which provides only modified and/or new image content.

As shown in the embodiment of FIG. 3 the system and device embodiments discussed above, can include a set of computer readable instructions which are operable to generate an index page having representations or thumbnails of the images that represent the contents of the received image data. As shown in the embodiment of FIG. 3, an index page will include a number of images, 302-1, . . . , 302-N, representing the contents of received image data. As shown on the index page embodiment of FIG. 3, each of the images representations, 302-1, . . . , 302-N, is provided with an associated image identifier, 303-1, . . . , 303-N. In the embodiment illustrated in FIG. 3, the associated image identifiers, 303-1, . . . , 303-N, are alphanumeric identifiers. As one of ordinary skill in the art will appreciate upon reading this disclosure, the image identifiers provided on an index page are not limited to any particular type of identifier symbol. That is, as one of ordinary skill in the art will appreciate, any symbol or shape suitable to distinguish, identify, or differentiate one image from another on the index page is included within the scope of the present invention.

As has been noted herein, the images identifiers, 303-1, . . . , 303-N, illustrated in FIG. 3, will change as the image content (represented by thumbnails, 302-1, . . . , 302-N, on the index page 300) from received image data changes. Hence, in previous devices, systems and methods, the image identifiers would have to be re-confirmed, e.g. through printing a new index page 300, each time image data was received.

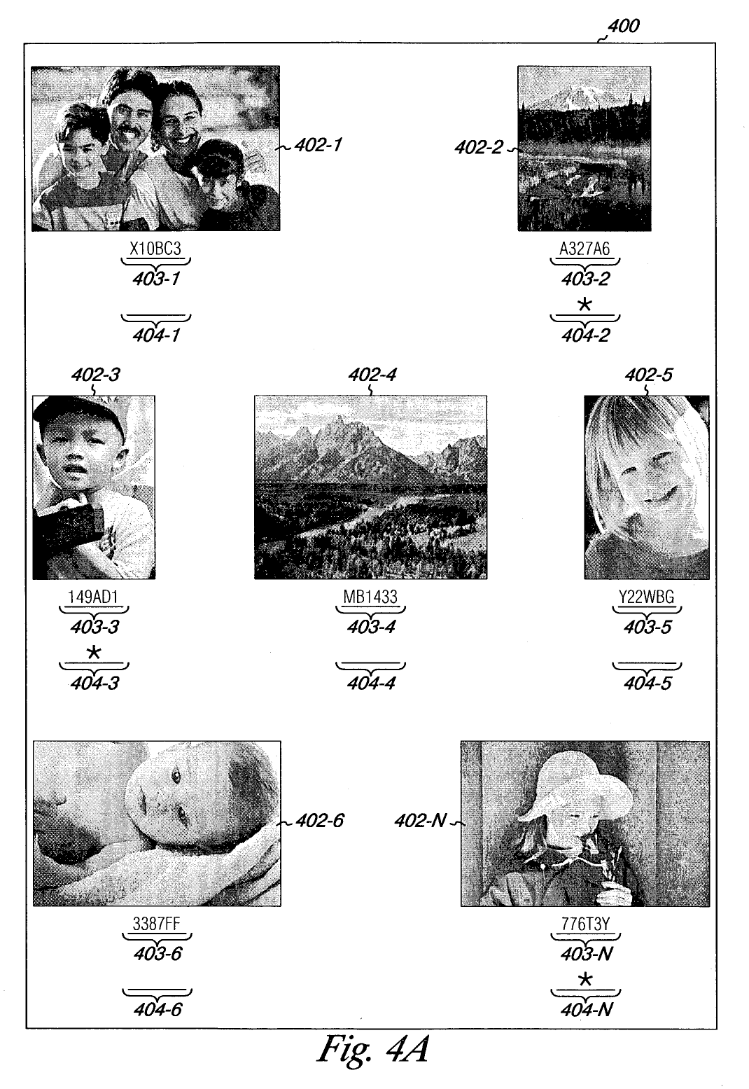

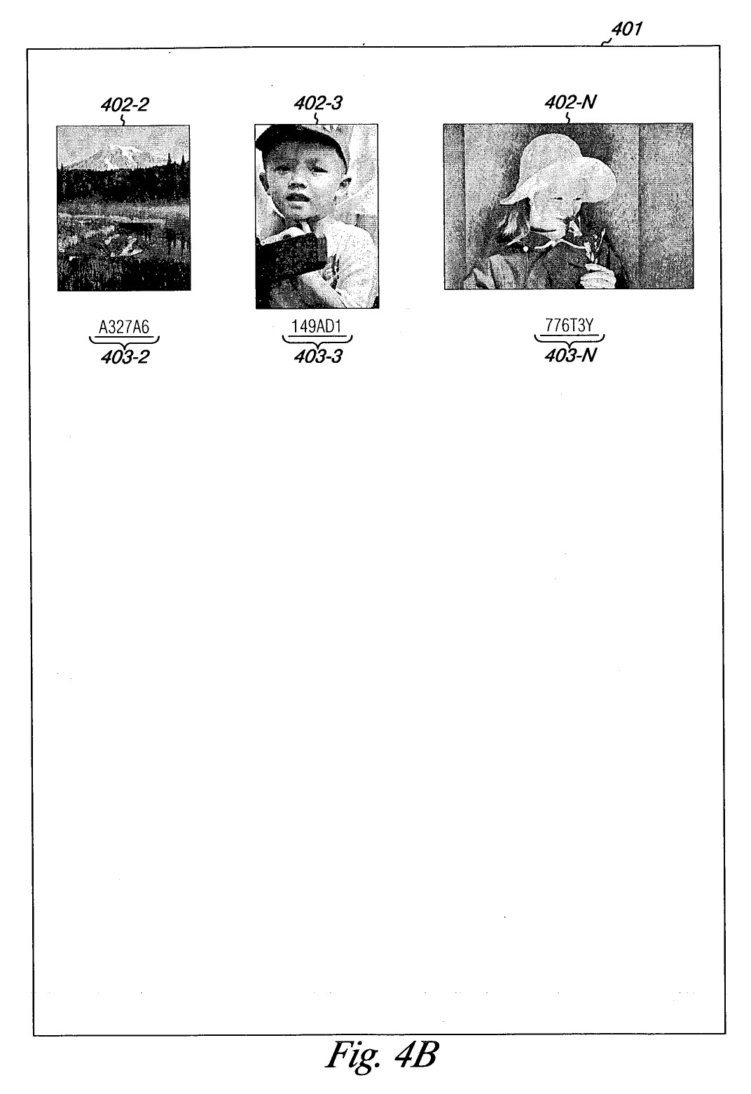

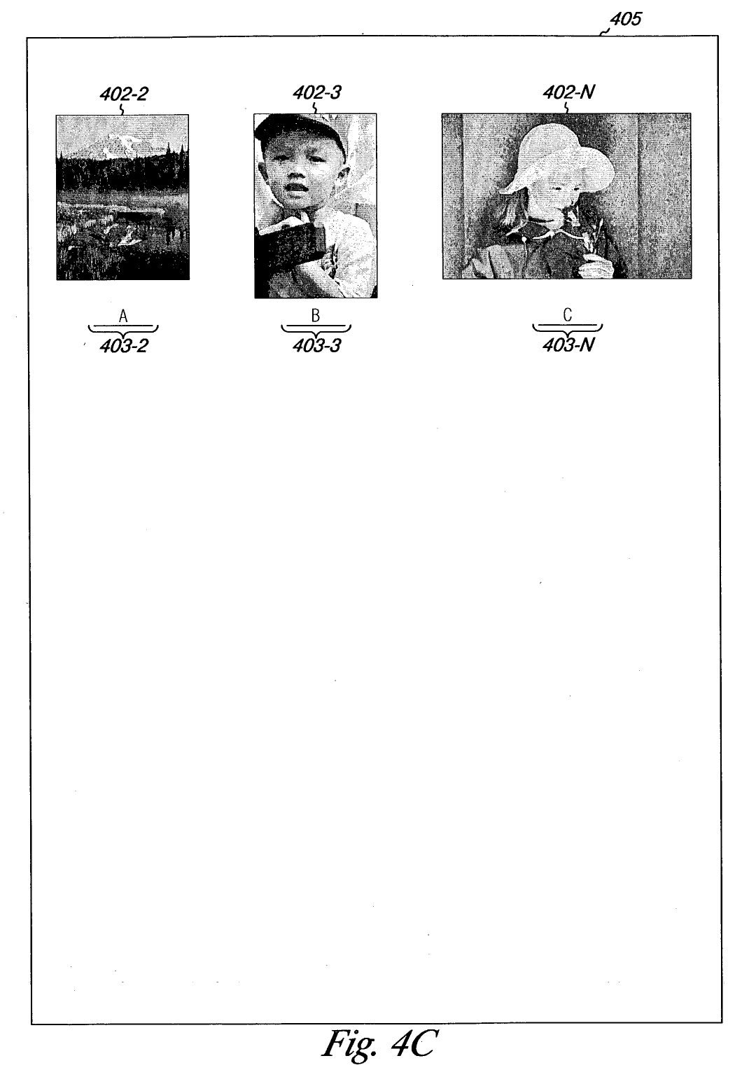

However, in various embodiments of the invention, a system or device, such as the devices and systems presented above, can provide for an indication of when image content in received image data has been modified from previously received image data. In various embodiments of the invention, an index page can be provided which reflects any changes or modifications to image content in received image data from previously received image data. Various embodiments for index pages according to the present invention are illustrated and discussed in connection with FIGS. 4A-4C.

FIGS. 4A-4C illustrate a number of index pages or index sheets which can be created and/or provided by a device or system, such as the systems and devices described herein, according to various embodiments of the present invention. FIGS. 4A-4C are used to illustrate various embodiments of the invention by which an index page can be provided which reflects any changes or modifications to image content in received image data from previously received image data.

FIG. 4A illustrates an embodiment of an index page or index sheet 400 according to the teachings of the present invention. In the embodiment of FIG. 4A, a system or device has received image data. As described in detail above, such image data can be received from any number of sources. That is, the image data can include image data received from a memory card, memory stick, CD, DVD, floppy disk, or the like, that has been inserted into a device, such as photo printer 202 or AiO 220. Likewise, image data can include image data received over a network from one or more remote devices, such as described in connection with network 100. Image data can also include image data received in a wireless manner such as through use of IR or Bluetooth technology. And, image data can also include image data received from scanned image data. The invention is not so limited.

As noted above, in various embodiments of the invention systems or devices include software operable thereon to receive and index the received image data. The software or set of computer executable instructions are operable in the various embodiments to provide an index sheet which reflects any changes or modifications to image content in received image data from previously received image data.

Thus, in the embodiment of FIG. 4A, an index page 400 is illustrated having a number of images, 402-1, . . . , 402-N, representing the contents of received image data. As shown on the index page 400 embodiment of FIG. 4A, each of the image representations, 402-1, . . . , 402-N, is provided with an associated image identifier, 403-1, . . . , 403-N. in the embodiment illustrated in FIG. 4A, the associated image identifiers, 403-1, . . . , 403-N, are alphanumeric identifiers. As one of ordinary skill in the art will appreciate upon reading this disclosure, the image identifiers provided on an index page are not limited to any particular type of identifier symbol. That is, as one of ordinary skill in the art will appreciate, any symbol or shape suitable to distinguish, identify, or differentiate one image from another on the index page is included within the scope of the present invention.

As shown on the index page 400 embodiment of FIG. 4A, each of the image representations, 402-1, . . . , 402-N, is further provided with an associated image modification identifier, 404-1, . . . , 404-N. As one of ordinary skill in the art will appreciate upon reading this disclosure, the associated image modification identifier, 404-1, . . . , 404-N, allows for identification of those images, e.g. images 402-2, 402-3, and 402-N, which have been modified in the received image content since image data was previously received from a particular source. As one of ordinary skill in the art will appreciate upon reading this disclosure, a user of the index page 400 can then more easily identify and focus upon the associated image identifiers, 403-2, 403-3, and 403-N, for those modified images, 402-2, 402-3, and 402-N.

FIG. 4B illustrates another embodiment of an index page or index sheet 401 according to the teachings of the present invention. In the embodiment of FIG. 4B, a system or device has received image data. As above, such image data can be received from any number of sources. As noted above, in various embodiments of the invention, systems or devices include software operable thereon to receive and index the received image data. The software or set of computer executable instructions are operable in the various embodiments to provide an index sheet which reflects any changes or modifications to image content in received image data from previously received image data.

In the embodiment of FIG. 4B, the systems and/or devices include one or more sets of computer executable instructions operable to provide an index page 401 having a number of images, 402-1, . . , 402-N, which represent only the modified content of received image data. As shown on the index page 401 embodiment of FIG. 4B, each of the image representations, 402-1, . . . , 402-N, is provided with an associated image identifier, 403-1, . . . , 403-N. In the embodiment illustrated in FIG. 4B, the associated image identifiers, 403-1, . . . , 403-N, are alphanumeric identifiers. Again, the image identifiers provided on an index page are not limited to any particular type of identifier symbol.

However, in the index page 401 embodiment of FIG. 4B, the image representations, 402-2, 402-3, and 402-N, reflect only image content in received image data which has been modified or altered from previously received image data. As one of ordinary skill in the art will appreciate upon reading this disclosure, providing image representations, 402-2, 402-3, and 402-N, on index page 401 which reflect only modified image content in received image data allows for identification of those images, e.g. images 402-2, 402-3, and 402-N, which have been modified in the received image content since image data was previously received from a particular source.

FIG. 4C illustrates another embodiment of an index page or index sheet 405 according to the teachings of the present invention. In the embodiment of FIG. 4C, a system or device has received image data. As above, such image data can be received from any number of sources. As noted above, in various embodiments of the invention systems or devices include software operable thereon to receive and index the received image data. The software or set of computer executable instructions are operable in the various embodiments to provide an index sheet which reflects any changes or modifications to image content in received image data from previously received image data.

In the embodiment of FIG. 4C, the systems and/or devices include one or more sets of computer executable instructions operable to provide an index page 405 having a number of images, 402-1, . . . , 402-N, which represent only the modified content of received image data. As shown on the index page 405 embodiment of FIG. 4C, each of the image representations, 402-1, . . . , 402-N, is provided with an associated image identifier, 403-1, . . . , 403-N.

In the index page 405 embodiment of FIG. 4C, the image representations, 402-2, 402-3, and 402-N, reflect only image content in received image data which has been modified or altered from previously received image data. In the embodiment illustrated in FIG. 4C, the one or more sets of computer executable instructions are further operable to provide an index of new images having a revised image indicator, e.g. A, B, and C, as each of the image associated image identifiers, 403-1, . . . , 403-N. In the embodiment of FIG. 4C, the revised image indicators, A, B, and C, are alphabetical characters. However, the invention is not so limited. In various embodiments, the revised image indicators provided as each of the image associated image identifiers, 403-1, . . . , 403-N can include a numerical image indicator having less than two digits.

As one of ordinary skill in the art will appreciate upon reading this disclosure, providing revised image indicators as each of the image associated image identifiers, 403-1, . . . , 403-N can facilitate an intelligent, quick and easy identification of the modified images, e.g. images 402-2, 402-3, and 402-N. The modified images, e.g. images 402-2, 402-3, and 402-N, are those which have been modified, among the received image content, since image data was previously received from a particular source. As one or ordinary skill in the art will appreciate, the various embodiments can lessen the amount of effort which has to be expended to insure the image indicator a user enters to a control panel on a printing device correctly references an image intended for printing.

As one of ordinary skill in the art will appreciate upon reading this disclosure, a user of the index page 400 can then more easily identify and focus upon the associated image identifiers, 403-1, . . . , 403-N, for those modified images, 402-2, 402-3, and 402-N. As one of ordinary skill in the art will appreciate upon reading this disclosure, the embodiment of FIG. 4B, accommodates printing a new index page containing only “new” or altered or modified images on the index page 401. As one of ordinary skill in the art will appreciate upon reading this disclosure, this embodiment obviates the need to print an index page when image content in received image data has not been modified since image data was previously received from a particular source. That is, in various embodiments, index page 401 will be printed only if image content has been modified. And, as one of ordinary skill in the art will appreciate upon reading this disclosure, a user of the index page 405 can more easily reference and accurately enter an image indicator which correctly corresponds to an image desired for printing. As one of ordinary skill in the art will appreciate upon reading this disclosure, embodiments of the present invention can include index pages which combine one or more of the features and embodiments described above. The invention is not so limited.

In various embodiments, the systems and/or devices described herein can automatically print an index page, 400, 401, and/or 405, according to the above described embodiments when new image content is detected in the received image data. In various embodiments, the systems and devices described herein can include a selectable key or data input, such as input key 214 in FIG. 2A. Depending on use, the systems and/or devices can print an index page 400 having image representations, 402-1, . . . , 402-N, each with an associated image modification identifier, 404-1, . . . , 404-N or, alternatively, a selectable key or data input, such as input key 214, can be actuated to print an index page 401 having only image representations, 402-2, 402-3, and 402-N, for image content in received image data which has been modified or altered from previously received image data. The invention, however, is not so limited. And, one of ordinary skill in the art will appreciate that other variations on these embodiments are considered within the scope of the present invention.

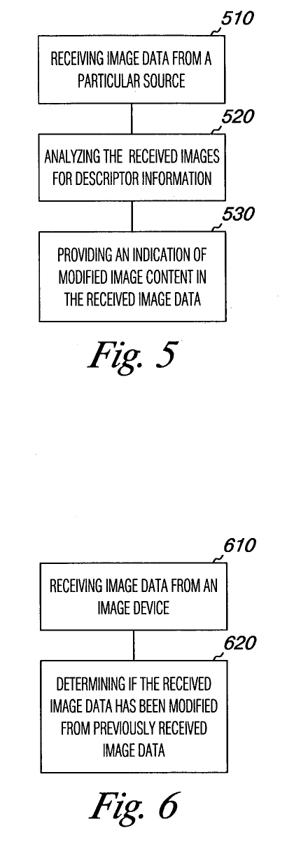

FIGS. 5-8 are block diagrams illustrating various method embodiments of the invention. As one of ordinary skill in the art will understand, the methods can be performed by software, application modules, and computer executable instructions operable on the systems and devices shown herein or otherwise. Such software, application modules, and/or computer executable instructions can be resident in one location or in several and even many locations, such as in a distributed computing environment, throughout a system as described above. The invention, however, is not limited to any particular operating environment or to software written in a particular programming language. Unless explicitly stated, the methods described below are not constrained to a particular order or sequence. Additionally, some of the so described methods can occur or be performed at the same point in time.

FIG. 5 is a block diagram illustrating a method according to an embodiment of the present invention. In the embodiment of FIG. 5, a method for indicating image content modification is provided. As illustrated in the embodiment of FIG. 5, the method includes receiving image data from a particular source at block 510. The method embodiment of FIG. 5 includes analyzing the received images for descriptor information at block 520. In various embodiments analyzing the received image data for descriptor information includes computing a partial Cyclic Redundancy Check (CRC) based on a subsampling of the received image data. In various embodiments, analyzing the received image data for descriptor information includes parsing the received image data into one or more classes of image data. In various embodiments, parsing image data into one or more classed includes grouping modified image content into an independent class.

At block 530, the method includes providing an indication of modified image content in the received image data based on the descriptor information. In various embodiments, providing an indication of modified image content includes printing an index page for an independent class of parsed, received image data. In various embodiments, providing an indication of modified image content includes printing an index page which identifies modified image content. And, in various embodiments, receiving image data from a particular source includes wirelessly receiving image data from a handheld device.

FIG. 6 illustrates another method embodiment for indicating image content modification according to the teachings of the present invention. As illustrated in the embodiment of FIG. 6, the method includes receiving image data from an image device at block 610. In various embodiments, receiving image data from an image device includes receiving image data from a digital camera.

As illustrated in the embodiment of FIG. 6, the method includes determining if the received image data has been modified from previously received image data at block 620. In various embodiments, determining whether the received image data has been modified includes comparing a global CRC candidate signature to a list of all recorded signatures in an image device memory. In various embodiments, comparing a global CRC candidate signature to a list of all recorded signatures in an image device memory includes comparing a global CRC candidate signature to a list of all recorded signatures in a non-volatile memory of an image device, such as a photo printer. The invention, however, is not so limited. In various embodiments, the method further includes providing a visual indication when image content in the received image data has been modified from the previously received image data. In various embodiments, providing a visual indication includes illuminating an icon on a photo printer control panel. The invention, however, is not so limited. In various embodiments, the method further includes providing an index which distinguishes altered image content.

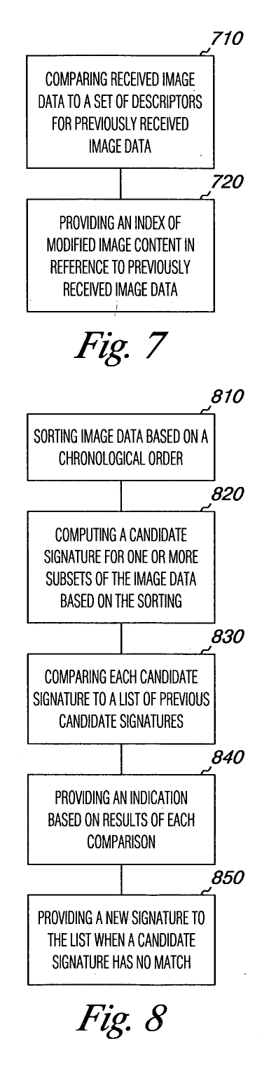

FIG. 7 illustrates another method embodiment for indicating image content modification according to the teachings of the present invention. As illustrated in the embodiment of FIG. 7, the method includes comparing received image data to a set of descriptors for previously received image data at block 710. In various embodiments, comparing received image data to a set of descriptors for previously received image data includes comparing received image data to a set of descriptors stored on a non-volatile memory of a printing device.

As illustrated in the embodiment of FIG. 7, the method includes providing an index of modified image content in reference to previously received image data at block 720. In various embodiments, providing an index of modified image content includes printing an index of new images. In various embodiments, providing an index of modified image content includes printing an index of new images having a revised image indicator for each image. In various embodiments, printing an index of new images having a revised image indicator includes printing an alphabetical image indicator. In various embodiments, printing an index of new images having a revised image indicator includes printing a numerical image indicator having less than two digits. The invention, however, is not so limited. In various embodiments, the method further includes receiving image data from a flash card.

FIG. 8 illustrates a method embodiment for comparing received image data to a set of descriptors for previously received image data. As shown in the embodiment of FIG. 8, the method includes sorting image data based on a chronological order at block 810. As illustrated in the embodiment of FIG. 8, the method includes computing a candidate signature for one or more subsets of the image data based on the sorting at block 820. At block 830, the method includes comparing each candidate signature to a list of previous candidate signatures.

In various embodiments, sorting the received image data based on a chronological order at block 810 includes computing a partial cyclical redundancy check (CRC) based on a subsampling of the received image data. In various embodiments, subsampling the received image data includes subsampling data file contents selected from the group of a first sector, a middle sector, and a last sector.

In various embodiments, computing a candidate signature for one or more subsets of the image data based on the sorting at block 820 includes computing a global CRC for each partial CRC. In various embodiments, comparing each candidate signature to the list of previous candidate signatures at block 830 includes comparing each candidate signature to a list of all recorded signatures stored in a memory in order to find a match.

As shown in the embodiment of FIG. 8, the method includes providing an indication based on results of each comparison, as shown in block 840. As illustrated at block 850, the method includes providing a new signature to the list when a candidate signature has no match.

In various embodiments, the method further includes indicating when descriptors in the received image data differ from a set of descriptors associated with previously received image data. In various embodiments, if a candidate's signature matches a recorded signature, but a valid image list is not exhausted, then indicating includes providing a first indication type. In various embodiments, providing a first indication type includes providing a first indication type to represent that remaining images on the valid image list have been added since a last time image data was received from a particular source, e.g. by introducing a memory card to a device or otherwise.

In various embodiments, if a valid image list is exhausted before a candidate signature matches any recorded signature, then indicating includes providing a second indication type. In various embodiments, providing a second indication type includes providing a second indication type to represent that received images are beyond indication with the valid image list. In various embodiments, the method further includes providing a new signature to the valid image list.

As one or ordinary skill in the art will appreciate upon reading this disclosure, providing a new signature to the valid image list can include providing a new signature when received image data has been introduced to a device from a new source, e.g. such as a first time a memory card is introduced to a device. And likewise, providing a new signature to the valid image list can include providing a new signature when received image data on the valid image list are beyond identification. In various embodiments, providing a new signature includes recording the new signature in a non-volatile memory of a device. And, in various embodiments, providing a new signature includes computing a new global CRC for the image candidate.

Thus, in various embodiments, a signature for received image data is performed as follows. All valid images, e.g. in files that contain a printable image, are scanned, indexed and then sorted based on a chronological order of each file's creation date. In this chronological order a partial CRC is computed based on a subsampling of the image data, e.g. file contents. In various embodiments, the file contents can be a first, middle, and/or last sector of a file. The invention is not so limited.

At the completion of each partial CRC, a global CRC is computed which constitutes a candidate signature. In various embodiments, this candidate signature can then be compared to a list of all recorded signatures stored in a device's non-volatile memory in order to find a match.

In various embodiments, if a candidate signature matches a recorded signature, but a list of valid files (valid image list) is not exhausted, an indication can be provided to represent that a remaining set of images on the valid image list have been added since a last time image data was received, e.g. by introducing a memory card to a device or otherwise.

In various embodiments, if a list of valid images is exhausted before a candidate signature matches any recorded signature, then an indication can be provided to represent that received image data has been altered beyond identification to any previously received image data. In various embodiments, an indication can similarly be provided to represent that the received image data has been introduced to a device from a new source, e.g. such as a first time a memory card is introduced to a device. In various embodiments, a new signature can be provided and recorded in a memory medium of a device, such as non-volatile memory, for future reference.

As one ordinary skill in the art will appreciate upon reading this disclosure, various embodiments of the invention can accord one or more of the following features. More image prints can be created with a higher level of confidence that an image number is in fact associated with a certain image, e.g. that a correct or intended image will be printed. Less mental calculations can be involved in deciphering and entering an image number for a particular image. Occasions in which unintended images are printed as a result of entering an incorrect image number can be diminished. Images on a particular memory medium can be tracked to retain and distribute. Consumables, such as print media can be conserved through a diminished need for printing index pages. A need for large amounts of device resident non-volatile memory can be avoided due to small signature memory requirements. In various embodiments, one or more sets of computer executable instructions are operable to keep track of image content from a unique source in order to evaluate if a “new” index page should be printed. As one of ordinary skill in the art will appreciate upon reading this disclosure, the above noted one or more features are neither an exhaustive list nor required of the embodiments in the present invention.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for indicating image content modification, comprising:
receiving image data from a particular source; and
analyzing the received image data for descriptor information; and
providing an indication of modified image content in the received image data based on the descriptor information.

2. The method of claim 1, wherein receiving image data from a particular source includes wirelessly receiving image data from a handheld device.

3. The method of claim 1, wherein analyzing the received image data for descriptor information includes computing a partial Cyclic Redundancy Check (CRC) based on a subsampling of the received image data.

4. The method of claim 3, wherein analyzing the received image data for descriptor information includes parsing the received image data into one or more classes of image data.

5. The method of claim 4, wherein parsing image data into one or more classes includes grouping modified image content into an independent class.

6. The method of claim 5, wherein providing an indication of modified image content includes printing an index page for the independent class.

7. The method of claim 1, wherein providing an indication of modified image content includes printing an index page which identifies modified image content.

8. A method for indicating image content modification, comprising:
receiving image data from an image device; and
determining if the received image data has been modified from previously received image data based on a CRC signature.

9. The method of claim 8, wherein receiving image data from an image device includes receiving image data from a digital camera.

10. The method of claim 8, wherein determining whether the received image data has been modified includes comparing a global CRC candidate signature to a list of all recorded signatures in an image device memory.

11. The method of claim 8, wherein the method further includes providing a visual indication when image content in the received image data has been modified from the previously received image data.

12. The method of claim 8, wherein the method further includes providing an index which distinguishes altered image content.

13. A method for indicating image content modification, comprising:
comparing received image data to a set of descriptors for previously received image data; and
providing an index of modified image content in reference to previously received image data based on the comparison.

14. The method of claim 13, wherein the method further includes receiving image data from a flash card.

15. The method of claim 13, wherein comparing received image data to a set of descriptors for previously received image data includes comparing received image data to a set of descriptors stored on a non-volatile memory of a printing device.

16. The method of claim 13, wherein providing an index of modified image content includes printing an index of new images.

17. The method of claim 16, wherein printing an index of new images includes printing an index of new images having a revised image indicator for each image.

18. A computer readable medium having a set of computer executable instructions thereon for causing a device to perform a method, the method comprising:
comparing received image data to a set of descriptors for previously received image data; and
indicating when descriptors in the received image data differ from the set of descriptors associated with the previously received image data.

19. The method of claim 18, wherein comparing received image data to a set of descriptors for previously received image data includes;
sorting received image data based on a chronological order;
computing a candidate signature for one or more subsets of received image data based on the sorting; and
comparing each candidate signature to a list of previous candidate signatures.

20. The method of claim 19, wherein sorting the received image data includes computing a partial cyclical redundancy check (CRC) based on a subsampling of the received image data.

21. The method of claim 20, wherein subsampling the received image data includes subsampling data file contents selected from the group of a first sector, a middle sector, and a last sector.

22. The method of claim 21, wherein computing a candidate signature includes computing a global CRC for each partial CRC.

23. The method of claim 19, wherein comparing each candidate signature to the list of previous candidate signatures includes comparing each candidate signature to a list of all recorded signatures stored in a memory in order to find a match.

24. The method of claim 23, wherein if a candidate's signature matches a recorded signature, but a valid image list is not exhausted, then indicating includes providing a first indication type.

25. The method of claim 24, wherein providing a first indication type represents that remaining images on the valid image list have been added since a last time image data was received from a particular source.

26. The method of claim 23, wherein if a valid image list is exhausted before a candidate signature matches any recorded signature, then indicating includes providing a second indication type.

27. The method of claim 26, wherein providing a second indication type represents that received images are beyond identification with the valid image list.

28. The method of claim 27, wherein the method further includes providing a new signature to the valid image list.

29. The method of claim 28, wherein providing a new signature includes recording the new signature in a non-volatile memory of a device.

30. An imaging device, comprising:
a processor;
a non-volatile memory operably coupled to the processor;
a data port to receive image data and operably coupled to the processor and non-volatile memory; and
software means operable on the device to detect when received image data includes image content which differs from previously received image content.

31. The imaging device of claim 30, wherein the imaging device includes a photo printer.

32. The imaging device of claim 31, wherein the imaging device includes an input key operable to print modified image content.

33. The imaging device of claim 30, wherein the imaging device includes an All-in-One (AiO) device.

34. The imaging device of claim 30, wherein the software means includes software operable to compare a set of descriptors in the received image data to a set of descriptors contained in the non-volatile memory.

35. The imaging device of claim 30, wherein the software means operable on the device to detect includes software operable to detect based on Cyclic Redundancy Checks (CRCs) computed on the received image data.

36. The imaging device of claim 30, wherein the software means includes software means operable to:
sort received image data based on a chronological order;
compute a candidate signature for one or more subsets of the received image data; and
compare each candidate signature to a list of previous candidate signatures.

37. An image transfer system, comprising:
a first device including:
a non-volatile memory; and
a processor operably coupled to the non-volatile memory, wherein the processor is operable on a set of computer executable instructions to detect when received image data includes image content which differs from previously received image content;
a second device operable to store image data thereon; and
one or more data links operable to transmit image data from the second device to the first device.

38. The image transfer system of claim 37, wherein the first device includes a photo printer.

39. The image transfer system of claim 37, wherein the second device includes a digital camera operable to record image data.

40. The image transfer system of claim 37, wherein the one or more data links includes a memory card.

41. The image transfer system of claim 37, wherein the one or more data links includes a wireless data link.

42. The image transfer system of claim 37, wherein the one or more data links includes one or more high speed serial, differential signal lines.
